(19) United States
(12) Patent Application Publication
(10) Pub. No.: US 2003/0037339 A1
(43) Pub. Date: Feb. 20, 2003

(54) Personal Web guide system and method for automatically displaying Web information

(75) Inventor: Chen-Yin Lee, Taipei (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: DynaLab, Inc.

(21) Appl. No.: 09/932,280

(22) Filed: Aug. 17, 2001

(51) Int. Cl. H04N 7/173; G06F 15/16

(52) U.S. Cl. 725/109; 725/110; 709/219

(57) ABSTRACT

The invention provides a personal Web guide system, which allows a user of a client system, in particular a computer-novice user, to enjoy viewing a sequence of Web pages automatically as predefined in a schedule program. Specifically, the system includes schedule program memory including a schedule program in which a plurality of Internet resource addresses are registered in predetermined sequential order. The personal Web guide system further includes a client system (TV settop box system, mobile phone, PC, etc.) including a display. The client system is configured to download plural sets of Internet resource data whose addresses are registered in the schedule program from the Internet, and to display the plural sets of downloaded data in the predetermined sequential order on the display.

### FIELD OF THE INVENTION

The invention is directed to user-interface software, and more particularly to software that allows a client system, such as a TV settop box system, personal digital assistant, or mobile phone, to automatically display Web information on the Internet according to a predetermined schedule.

### BACKGROUND OF THE INVENTION

Web information available on the Internet is displayed on a client system via a Web browser operating on the client system. Typically, a client computer user accesses Web information by directly entering a URL (Universal Resource Locator) of a desired Web page into the browser, by using a search engine to locate several Web pages of interest and selecting one of them, or by moving and clicking a mouse on a hyperlink to the URL displayed on a screen. The browser will then download a Web page from the specified URL and display the Web page on the computer screen.

Over the last decade or so, the Internet has become widely accessible to an increasing number of people. More recently, the Internet has become accessible to even those people who do not necessarily own a personal computer (PC). For example, people can now use mobile phones or personal digital assistants (palms) to access the Internet via wireless channels. Also, a conventional television set (TV) can be turned into a device for accessing the Internet by simply coupling a TV settop box to the TV. However, for those computer novices who are not familiar with maneuvering a mouse or even typing, finding a desired Web page can be a substantial challenge. In particular, one market research conducted in connection with the sale of TV settop box systems showed that people with little or no computer experience tend to resist the use of a mouse or any other conventional input device in searching for desired Web information. Rather, they quickly become frustrated by seemingly endless searching for desired Web information. Thus, currently, those computer novices are not able to fully enjoy the advantage of the Internet access.

Accordingly, a need exists for a personal Web guide system, which would assist computer novices in viewing desired Web information with ease.

### SUMMARY OF THE INVENTION

The present invention provides a personal Web guide system, which allows a user of a client system, in particular a computer-novice user, to enjoy viewing a sequence of desired Web pages without having to constantly maneuver any input device. To this end, the sequence of Web pages are automatically displayed on the client system according to a predefined schedule program. Specifically, the personal Web guide system includes schedule program memory including a schedule program, in which a plurality of Internet resource addresses are registered in predetermined sequential order. The personal Web guide system further includes a client system (TV settop box system, mobile phone, personal digital assistant, PC, etc.) including a display. The client system is configured to download plural sets of Internet resource data whose addresses are registered in the schedule program from the Internet, and to display the downloaded plural sets of data in the predetermined sequential order on the display.

In accordance with one aspect of the present invention, the schedule program memory resides in a host server with which the client system is connected via the Internet and from which the client system retrieves the schedule program.

In accordance with another aspect of the present invention, the schedule program memory includes a plurality of schedule programs predefined under a plurality of categories, respectively, and any of the programs can be selected and retrieved by the client system.

In accordance with still another aspect of the present invention, the client system may be a TV settop box system, a mobile phone, or a personal digital assistant. The schedule program may further define scrolling of the Internet resource data in case the Internet resource data are too large to be displayed in a single view on the screen of the particular client system. Additionally, the schedule program may still further define reformatting of the Internet resource data in case the Internet resource data are not suitably formatted for display on the screen of the particular client system.

In accordance with a further aspect of the present invention, the schedule program also defines a display period of each of the plural sets of Internet resource data, and the client system displays each of the plural sets of Internet resource data for the predefined display period.

In accordance with a still further aspect of the present invention, the client system includes a display and a buffer configured to store Internet resource data. The client system is capable of downloading a set of Internet resource data from the next Internet resource address as registered in the schedule program before completing the display of another set of Internet resource data from the current Internet resource address as registered in the schedule program. This arrangement is advantageous in reducing or eliminating time that the user would otherwise have to waste in downloading the next set of Internet resource data.

In one specific embodiment, a personal Web guide system includes generally three components. The first component is a host workstation including a schedule program memory. The memory includes a schedule program in which a plurality of Internet resource addresses are registered in predetermined sequential order. The second component is a schedule program server connected to the host workstation. The schedule program server is configured to receive a schedule program and to create a plurality of temporary Web pages and a display control program based on the received schedule program. The third component is a client system including a display. The client system is configured to download the display control program from the schedule program server, and then to download and display the temporary Web pages in the predetermined sequential order according to the downloaded display control program.

The present invention also offers software for creating a schedule program as described above. The software generally performs two steps: receiving user input of a plurality of Internet resource addresses and their sequential order; and generating a schedule program in which the plurality of Internet resource addresses are registered in the predetermined sequential order. The software may be embodied in a recordable data storage medium, such as magnetic, optical, biological, and atomic data storage media, or in a computer-readable modulated carrier signal.

The present invention also offers software containing a schedule program in which a plurality of Internet resource addresses are registered in predetermined sequential order.

The present invention further offers software for executing a schedule program on a client system. The software generally performs two steps: downloading a display control program in which a plurality of Internet resource addresses are registered in predetermined sequential order; and downloading and displaying the plural sets of Internet resource data available at the plurality of Internet resource addresses, respectively, in the predetermined sequential order according to the display control program.

The invention still further offers a method of automatically displaying a series of Web pages on a client system. The method generally includes three steps. First, a plurality of categories are listed on a client system, wherein each of the categories is associated with a schedule program. Second, a user selection of one of the categories is received at the client system. Third, in response to the user selection, a plurality of Web pages are automatically displayed on the client system in sequence as predetermined in the schedule program associated with the selected category.

As will be apparent from the foregoing, according to the present invention, a series of Web pages programmed in a schedule program are automatically displayed on the screen of a client system, and thus the user, in particular a computer-novice user, can enjoy viewing the Web pages without having to constantly manipulate any input device of the client system. Further, because the next Web page may be downloaded while the current Web page is still on display, and because the display period of a Web page is typically longer than the time required to download another Web page, the user can view the next Web page immediately after finishing viewing the current page. Thus, the user does not have to wait between Web pages.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an illustrative operating environment for implementing a personal Web guide system of the present invention;

FIG. 2 is a block diagram depicting an illustrative architecture of a client system;

FIG. 3A is a block diagram depicting an illustrative architecture of a host workstation storing a plurality of schedule programs;

FIG. 3B is a block diagram depicting an illustrative architecture of a schedule program server;

FIG. 4 is a schematic illustration of a schedule program;

FIG. 5 is a data flow diagram illustrating the data flow among the client system, host workstation, schedule program server, and various Web servers, in accordance with one embodiment of the present invention;

FIG. 6 is a sample schedule program Web page to be displayed on the client system, listing a plurality of selectable categories each associated with a schedule program;

FIG. 7A is a flowchart illustrating the steps to be performed by a schedule program creator to generate a schedule program and store the generated schedule program in the host workstation, in accordance with one embodiment of the present invention;

FIG. 7B is a sample screen shot of a schedule program editing system, prompting a schedule program creator to define certain features of a Web page to be registered in a schedule program;

FIG. 8 illustrates sample syntax used to create the computer-readable form of a schedule program;

FIG. 9A is a sample screen shot of the schedule program editing system, prompting a schedule program creator to define attributes of a schedule program;

FIG. 9B is a sample screen shot of the schedule program editing system, allowing a schedule program creator to confirm his/her selection and arrangement of Web pages in a schedule program;

FIG. 10 is a flowchart illustrating the operation of a schedule program server in accordance with one embodiment of the present invention;

FIG. 11 is a flowchart illustrating the operation of a client system in accordance with one embodiment of the present invention;

FIG. 12 is a flowchart illustrating the detailed steps involved in step 162 of FIG. 11; and

FIG. 13 is a sample remote control that can be used as an input device for a TV settop box system.

### DETAILED DESCRIPTION OF THE PREFERRED EMBODIMENT

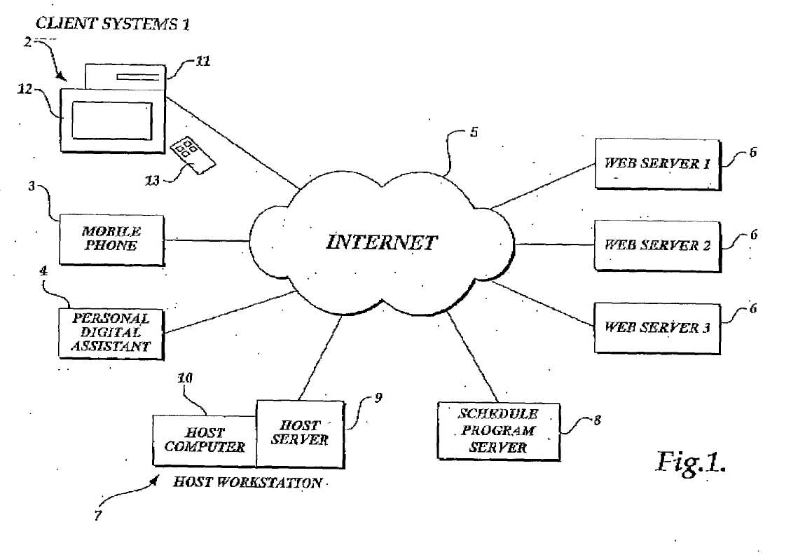

FIG. 1 depicts an illustrative operating environment suitable for implementing a personal Web guide system of the present invention. One or more client systems 1, such as a TV settop box system 2, a mobile phone 3, and a personal digital assistant (palm) 4 are connected to the Internet 5. The TV settop box system 2 comprises a TV settop box 11 connected to, and typically placed on top of, a conventional home TV 12. Also, the TV settop box 11 includes an input device, such as an infrared-based remote control device 13. The client system 1 may be selected from among other types of computing devices, such as a personal computer, a portable computer, pager, and the like, as will be apparent to those skilled in the art. To view a specific Web page, the client system 1 specifies the URL for the Web page in a request (e.g., a HyperText Transfer Protocol request) using a Web browser executing on the client system. The request is forwarded to the Web server 6 that supports the Web page, and the Web server 6 transmits the Web page (or Web information) to the client system via the Internet 5. The configuration and operation of the Internet are well known in the art, and thus are not described in further detail. It is noted, though, that in accordance with one embodiment of the present invention, a host workstation 7 and a schedule program server 8 are also connected to the Internet. The host workstation 7 includes a host server 9 that supports a schedule program Web page, at which the users of the client systems 1 can select a schedule program, and a host computer 10 that may be used to create and maintain the schedule program Web page on the host server 9. The schedule program server 8 includes facilities to construct a series of Web pages according to a schedule program, and to transmit those Web pages to the client system 1 for display. The configuration and operation of the host workstation 7 and the schedule program server 8 will be more filly described later.

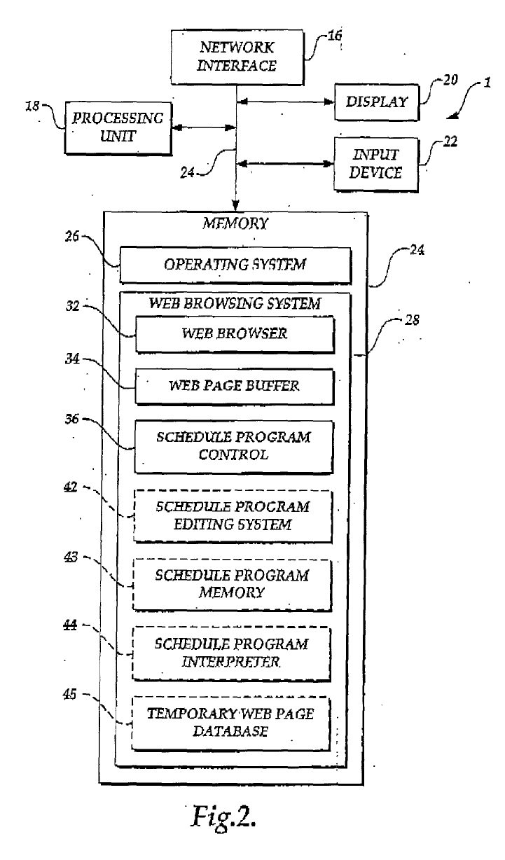

FIG. 2 depicts several key components of an exemplary client system 1. Those of ordinary skill in the art will appreciate that the client system 1 may include many more components than those shown in FIG. 2. However, it is not necessary that all of these generally conventional components be shown in order to disclose an illustrative embodiment of the present invention. As shown, the client system 1 includes a network interface 16 for connecting to the Internet. Those of ordinary skill in the art will appreciate that the network interface 16 includes the necessary circuitry for such connection. The client system 1 also includes a processing unit 18, a display 20, an input device 22, and memory 24, all interconnected along with the network interface 16 via a bus 24. The input device 22 may be any conventional input device, including a keyboard, mouse, and any other pointing device. In the case of a TV settop box system 2 (FIG. 1), a conventional TV set 12 serves as the display 20 and a remote control device 13 serves as the input device 22. The memory 24 typically comprises a random-access memory (RAM), a read-only memory (ROM), and a permanent mass storage device, such as a disk storage device, as known in the art. The memory 24 stores an operating system 26 for controlling the operation of the client system 1. The memory 24 also stores a Web browsing system 28 for controlling the Web access of the client system 1. The Web browsing system 28 includes a Web browser 32, a Web page buffer 34, and a schedule program control 36. The Web browsing system 28 may further include a schedule program editing system 42, a schedule program memory 43, a schedule program interpreter 44, and a temporary Web page database 45. The operation of these various components will be more fully described later.

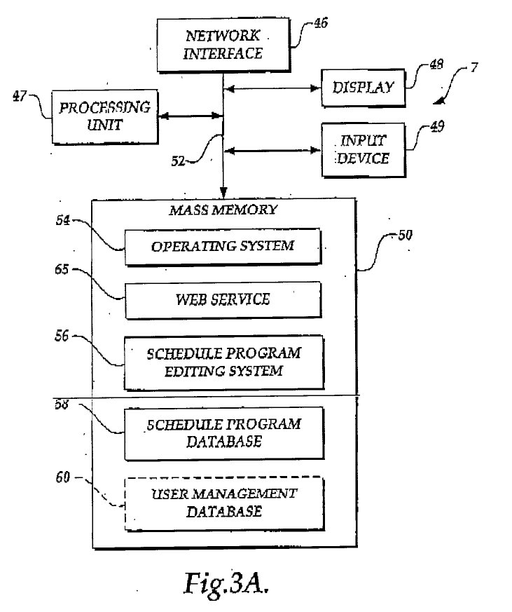

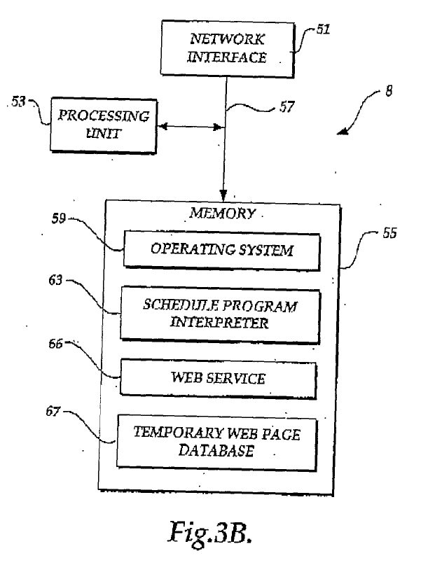

FIG. 3A depicts several of the key components of the host workstation 7, which may comprise any standard workstation known in the art. As before, those of ordinary skill in the art will appreciate that the host workstation 7 includes many more components than those shown in FIG. 3A. However, it is not necessary that all of these generally conventional components be shown in order to disclose an illustrative embodiment of the present invention. As shown in FIG. 3A, the host workstation 7 is connected to the Internet via a network interface 46. The workstation 7 also includes a processing unit 47, a display 48, an input device 49, and mass memory 50, all interconnected along with the network interface 46 via a bus 52. The mass memory 50 stores an operating system 54 for controlling the operation of the workstation 7. The mass memory 50 also includes a Web service 65 for supporting a schedule program Web page. The mass memory 50 still further includes a schedule program editing system 56 for creating and/or editing schedule programs and a schedule program database 58 for storing the created schedule programs. Finally, the mass memory 50 may also include a user management database 60 for storing data related to the subscribing users of the schedule programs, as will be more fully explained later. As described above, the host workstation 7 includes the host server 9, which is generally a Web server supporting a schedule program Web page, and the host computer 10, which is used to create and maintain the schedule program Web page on the host server 9. Thus, in FIG. 3A, it is contemplated that the display 48, the input device 49, and the schedule program editing system 56 may physically reside in the host computer 10 and the network interface 46, the Web service 65, and the schedule program database 58 may physically reside in the host server 9, though of course the components of the host workstation 7 may be distributed between the host computer 10 and the host server 9 in various ways.

FIG. 3B depicts several of the key components of the schedule program server 8. The schedule program server 8 may comprise any standard server system known in the art. As before, those of ordinary skill in the art will appreciate that the schedule program server 8 includes many more components than those shown in FIG. 3B. However, it is not necessary that all of these generally conventional components be shown in order to disclose an illustrative embodiment of the present invention. As shown in FIG. 3B, the schedule program server 8 is connected to the Internet via a network interface 51. The server 8 also includes a processing unit 53 and memory 55, both interconnected along with the network interface 51 via a bus 57. The memory 55 stores an operating system 59 for controlling the operation of the server 19. The memory 55 also includes a schedule program interpreter 63 for receiving a schedule program and interpreting the received schedule program to construct a sequence of Web pages registered in the schedule program. Specifically, the schedule program interpreter 63 controls a Web service 66 also included in the memory 55 to access and download these Web pages from their respective Web servers. The constructed sequence of Web pages are then stored in a temporary Web page database 67 in the memory 55. The function of these various components will be more fully described later.

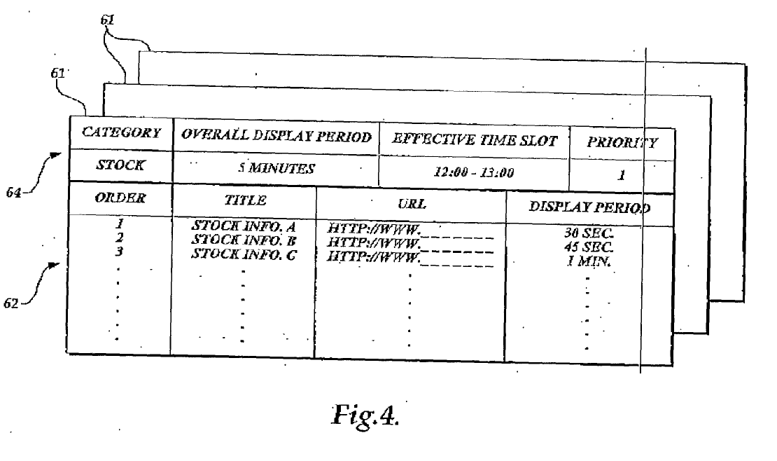

Next referring to FIG. 4, a sample schedule program is illustrated. A schedule program 61 includes a list 62 of a plurality of Web pages to be displayed on the client system, and a set of attributes 64. Specifically, the list 62 includes the title, URL, and display period of each Web page selected to be displayed in sequential order. The illustrated list 62 specifies that the client system automatically displays Web page “Stock Info. A” for 30 seconds, then Web page “Stock Info. B” for 45 seconds, and then Web page “Stock Info. C” for 1 minute, and so on. The set of attributes 64 may define the category (“Stock” in the illustrated example), overall display period (the total of all display periods), effective time slot (when the schedule program is available), and priority of the particular schedule program, as will be more fully explained later.

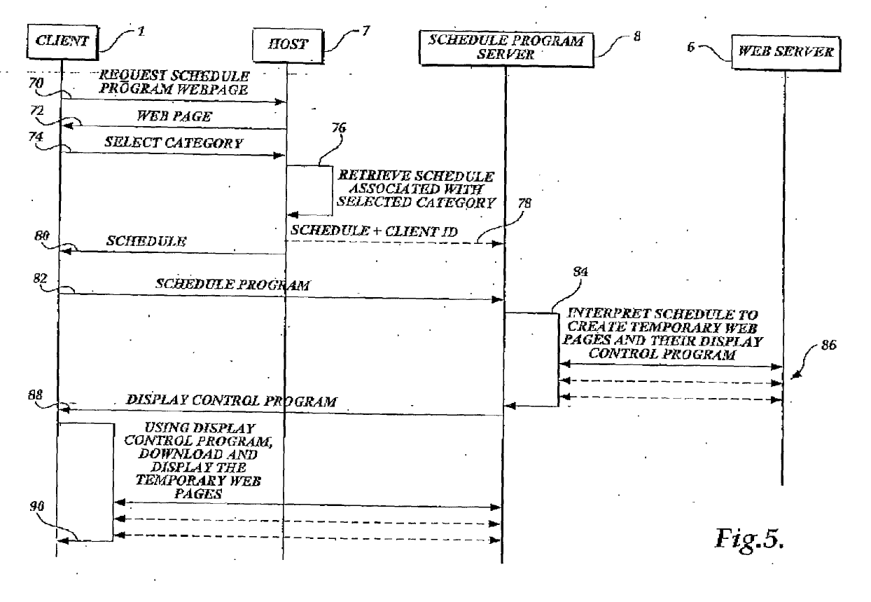

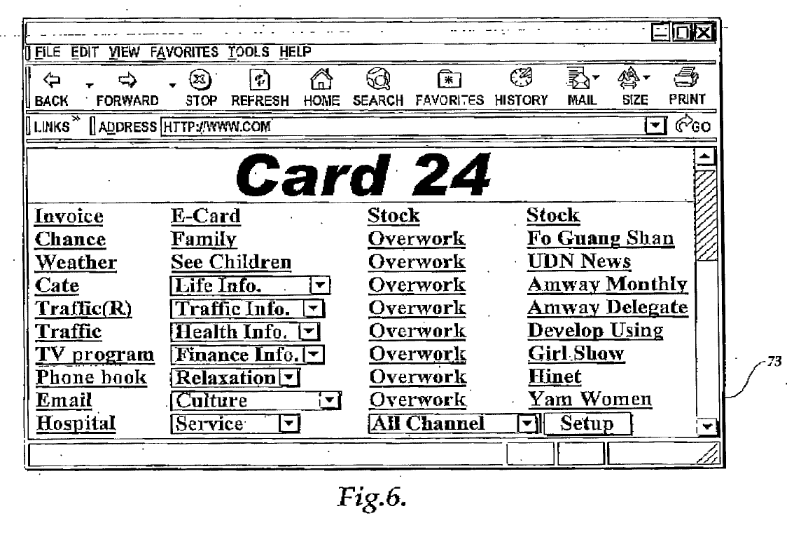

FIG. 5 illustrates the overall data flow in a personal Web guide system in accordance with one embodiment of the present invention. Specifically, FIG. 5 illustrates data flow amongst the client system 1, host workstation 7, schedule program server 8, and one or more Web servers 6 supporting various Web pages of interest (FIG. 1). First, in line 70, the client system 1 sends a request to the host workstation 7 for a schedule program Web page. This may be done using any method, e.g., by directly entering the URL of the schedule program Web page on the client system 1 or activating a hyperlink (or shortcut) on the client system 1 to the schedule program Web page. In line 72, in response to the request, the host workstation 7 transmits the schedule program Web page to the client system 1. A sample schedule program Web page 73 is shown in FIG. 6. As illustrated, the schedule program Web page lists a number of selectable categories. Each category is associated with one or more predefined schedule programs, as will be more fully explained later. Further, as shown, some of the categories include a pull-down menu to list a number of sub-categories selectable thereunder. In this case, each of the subcategories is also associated with one or more predefined schedule programs.

Referring back to FIG. 5, in line 74, the user selects a desired category, for example, by clicking on the category. Then, in line 76, the host workstation 7 retrieves a schedule program associated with the selected category from the schedule program database 58 (FIG. 3A). If more than one schedule program are associated with the selected category, the host workstation 7 selects one of the programs according to suitable criteria, as will be more fully described below. Thereafter, in line 78, the host workstation 7 may send the retrieved schedule program, together with the identifier of the client system 1 that selected the category for the schedule program, to the schedule program server 8. Alternatively, in line 80, the host workstation 7 may send the retrieved schedule program back to the client system 1 which, in line 82, would then send the received schedule program to the schedule program server 8. In line 84, the schedule program server 8 interprets the received schedule program and creates temporary Web pages and their display control program. In other words, the schedule program server 8 accesses the Web servers 6 that support the Web pages registered in the received schedule program (line 86), and constructs a sequence of temporary Web pages (embodying the registered Web pages) to be displayed on the client system 1. The schedule program server 8 also creates a display control program that defines the manner in which the temporary Web pages are to be displayed on the client system 1. Thereafter, in line 88, the schedule program server 8 first transfers the display control program to the client system 1. Next, in line 90, using the received display control program, the client system 1 downloads and displays the temporary Web pages from the schedule program server 8.

As will be appreciated from the foregoing, when the user of the client system 1 accesses the schedule program Web page (line 70) and selects a desired category (line 74), a sequence of Web pages that are pre-selected and pre-arranged in the schedule program associated with the selected category will be automatically displayed on the client system 1 (line 90). Therefore, a personal Web guide system of the present invention is highly advantageous in allowing a client system user to enjoy viewing a plurality of Web pages with a minimum level of operation required on his or her part.

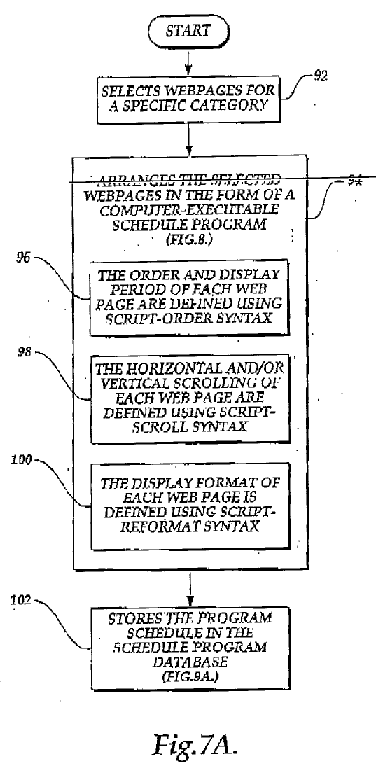

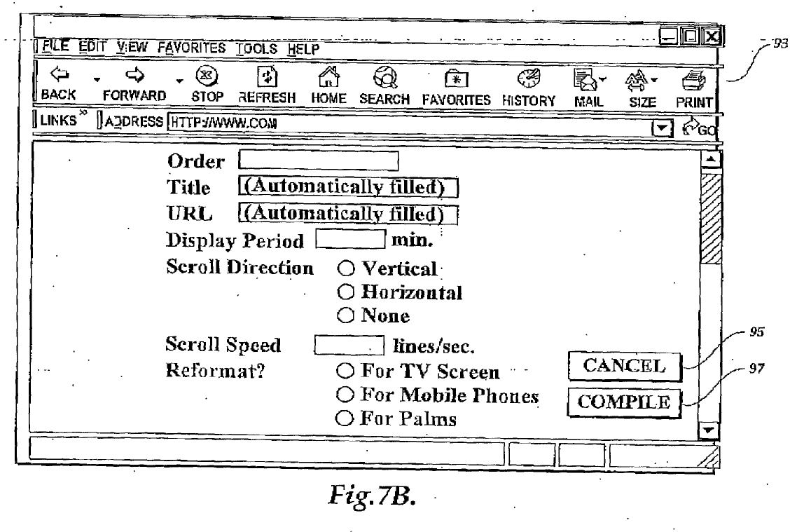

Next referring to FIG. 7A, the steps that a schedule program creator may perform to generate a schedule program (as shown in FIG. 4) are described. In one embodiment, it is contemplated that the schedule program creator is a person perhaps associated with the provider or manufacturer of a personal Web guide system who maintains the host workstation 7 and the schedule program server 8. In another embodiment, however, it is also contemplated that the schedule program creator may be a client system user himself or herself, who will create a schedule program according to his or her own preferences. It is noted, though, that a client system user must be at least minimally familiar with how to browse Web information in order to create his or her own schedule program.

In step 92, the schedule program creator selects a plurality of Web pages desired to be included in a schedule program under a specific category. Some examples of categories are found in FIG. 6, which shows a sample schedule program Web page. There are various ways to select a number of desired Web pages. For example, when the creator is not a client system user, the creator may first come up with a plurality of categories, and then select Web pages that fall under each of the categories. As another example, a client system user or a group of client system users may request a schedule program creator to select Web pages according to the user(s)' particular preference and interest. The creator then collects suitable Web pages and consults with the user(s) to seek the user(s)' approval of the collection. In this case, the “category” of the collection may be advantageously titled as the name of the user or the group of the users, so that the user(s) can easily identify their own custom-made schedule program in the schedule program Web page.

Next, in step 94, the schedule program creator arranges the selected Web pages in the form of a computer-readable schedule program. In one embodiment, this can be done using a schedule program editing system (56 in FIG. 3A or 42 in FIG. 2). Specifically, once the creator selects a desired Web page to be included in a schedule program, the schedule program editing system 56 (or 42) may display a schedule program definition window 93 as shown in FIG. 7B, prompting the creator to define various features of the Web page. Specifically, in the illustrated embodiment, the window 93 requests the creator to input information such as: the order in which the Web page is to be registered in the schedule program; the title of the Web page (perhaps automatically filled in upon selection of the Web page); the URL of the Web page (also automatically filled in upon selection of the Web page); the display period of the Web page (in seconds, minutes, etc.); the direction of scrolling necessary for display on a particular client system; the scroll speed (e.g., the number of lines per second); and any reformatting information (e.g., to be reformatted for display on a TV screen, for display on a standard mobile phone screen, or for display on a standard personal digital assistant display). At any time, the creator may select a cancel button 95 in the schedule program definition window 93 to cancel the definition process, close the window 93, and to go back to finding a desirable Web page. Once the creator enters all requested information in the schedule program definition window 93, the creator may select a compile button 97 in the window 93 to create a schedule program in the form of computer-readable script syntax based on the information that the creator has entered.

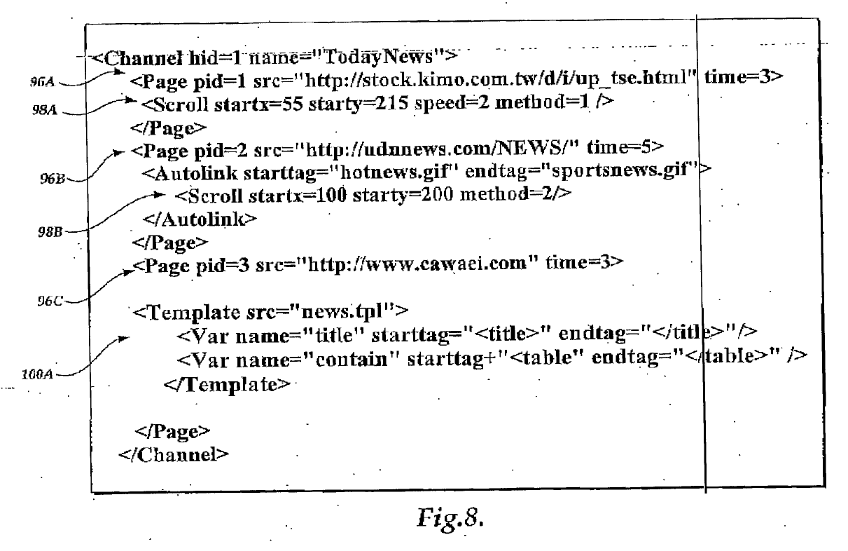

Samples of computer-readable script syntax are shown in FIG. 8. Referring back to FIG. 7A, the step of generating a computer-readable schedule program (step 94) generally includes three sub-steps 96, 98, and 100. In sub-step 96, the order in which the selected Web pages will be displayed and also how long each of the Web pages will be displayed (display period) are defined using script-order syntax. FIG. 8 lists sample script-order syntax 96A, 96B, and 96C, each defining a selected Web page's URL and its display period. In FIG. 7A, sub-step 98, the horizontal and/or vertical scrolling of each Web page, if any, are defined using script-scroll syntax. As described above, scrolling may be necessary when a Web page in its original form is too large to fit in a screen of a particular client system, such as a TV settop box system or a mobile phone. FIG. 8 lists sample script-scroll syntax 98A and 98B, each defining the direction of scrolling, scroll speed, etc. Referring again back to FIG. 7A, sub-step 100, a new display format (i.e., reformatting) for each Web page, if any, is defined using script-reformat syntax. Reformatting may be preferable or necessary because the format of some Web pages that are to be displayed on a conventional PC screen may not be suitable for display on a screen of a selected client system (e.g., a TV screen). FIG. 8 lists sample script-reformat syntax 100A. It should be appreciated that if the creator is familiar with script syntax, he or she may write a computer-readable schedule program, as shown in FIG. 8, without using the schedule program editing system 56 (or 42) of FIG. 3A (or FIG. 2).

Once a computer-readable schedule program is prepared, in FIG. 7A, step 102, the creator stores the generated schedule program in the schedule program database 58 of the host workstation 7 (FIG. 3A). Alternatively, if the creator is the user of a client system, the creator stores the schedule program in the schedule program memory 43 of the client system 1 (FIG. 2). It will be further appreciated that the schedule program may be stored in any other device that the client system 1 can access via the Internet.

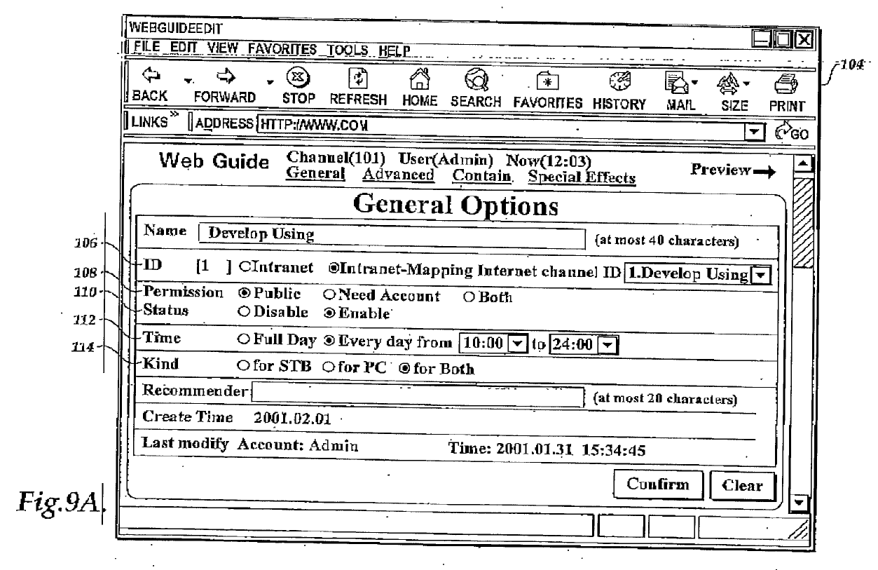

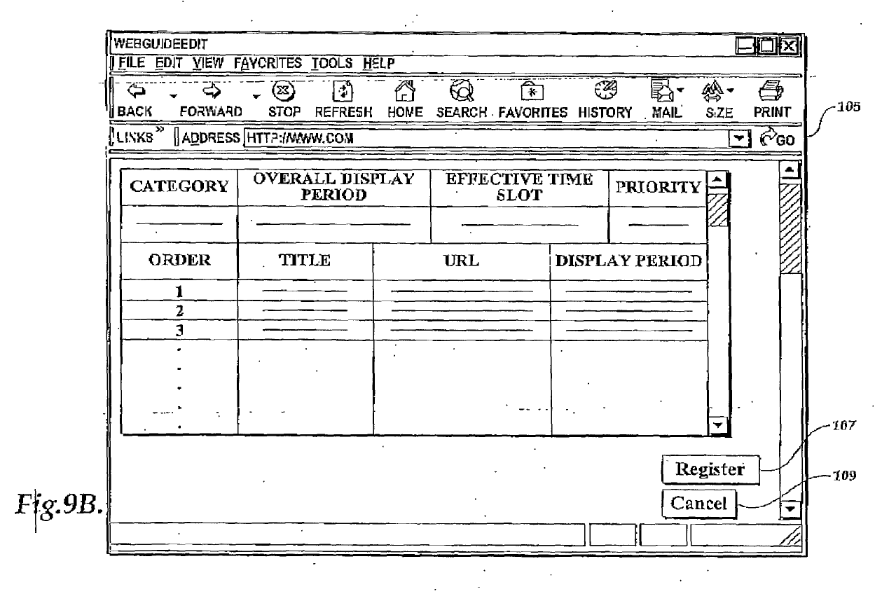

When the creator selects the schedule program to be stored using the schedule program editing system 56 (or 42), the editing system may display an attribute definition window 104 as shown in FIG. 9A, prompting the creator to input various attributes of the schedule program. For example, in the illustrated embodiment, the attribute definition window 104 solicits information such as: in what type of network the schedule program is available (106), who can access the schedule program (108), the status of the schedule program, disabled or enabled(110), the time of the day the schedule program is available, i.e., the effective time slot (see FIG. 4) (112), and the kind of client system that the schedule program is designed for (114). Those skilled in the art will appreciate that various other attributes may be defined and associated with each schedule program. The defined attributes are also stored in association with the schedule program.

Optionally, after the schedule program is fully defined and stored in suitable memory as described above, the schedule program editing system 56 (or 42) may display a schedule program confirmation window 105 as shown in FIG. 9B to allow a schedule program creator to further confirm his or her selection and arrangement of Web pages. Specifically, in the illustrated embodiment, the confirmation window 105 lists the selected Web pages in defined order, and also the title, URL, display period, and any other pertinent information of each of the Web pages. The window 105 may also list the attributes of the schedule program, such as its category, overall display period, effective time slot, and priority. It is contemplated that the schedule program creator opens the window 105 to confirm the arrangement of the schedule program. If no change is to be made, the creator selects a cancel button 109 in the window 105 to simply close the window 105. On the other hand, if the creator wishes to make changes to the schedule program, he or she can do so within the confirmation window 105. For example, the creator may use a drag-and-drop operation to change the order of the Web pages, delete one or more rows of Web pages, or even insert one or more rows of Web pages by typing or pasting the title, URL, and display period of each Web page to be inserted. The creator may also change the category, effective time slot, or priority of the schedule program. Thereafter, when the creator selects a register button 107 in the confirmation window 105, any change made in the confirmation window 105 will be automatically reflected in the computer-readable form of the schedule program as stored in suitable memory in step 102 of FIG. 7A, and the confirmation window 105 is closed.

The schedule program creator repeats the process of FIG. 7A until a desired number of schedule programs are created and stored.

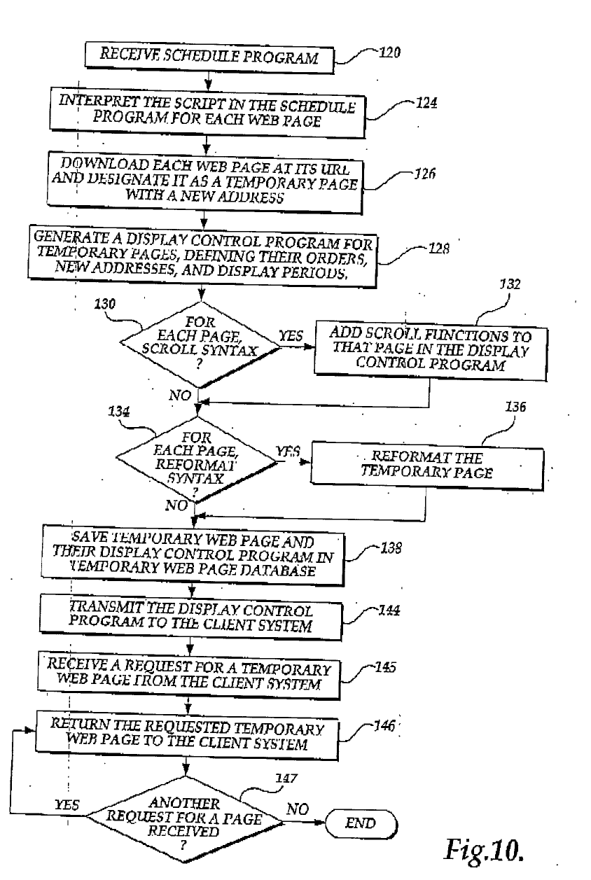

FIG. 10 illustrates operation of the schedule program server 8 in accordance with one embodiment of the present invention. As described above in reference to FIG. 5, the schedule program server 8 receives a selected schedule program from the client system 1 (or from the host workstation 7) and interprets the received schedule program (line 84). Specifically, referring additionally to FIG. 3B, in FIG. 10, step 120, the server 8 receives a schedule program from, for example, the client system 1. In step 124, the schedule program interpreter 63 interprets the computer-readable script for each Web page registered in the schedule program. In step 126, the schedule program interpreter 63 controls the Web service 66 to download each Web page registered in the schedule program. Each downloaded Web page is then designated as a temporary Web page with a new address in the temporary Web page database 67. In step 128, the schedule program interpreter 63 generates a display control program for the temporary Web pages registered in the schedule program. The display control program defines the order, the new address and, preferably, the display period of each of the Web pages as specified in the script-order syntax in the schedule program. In step 130, if it is determined that the schedule program includes script-scroll syntax for any of the Web pages, in step 132, the schedule program interpreter 63 adds the specified scroll functions to that Web page in the display control program. In step 134, if it is determined that the schedule program further includes script-reformat syntax for any of the Web pages, in step 136, the schedule program interpreter 63 reformats that temporary Web page according to the syntax. In step 138, the schedule program interpreter 63 saves the temporary Web pages and the display control program at the designated addresses in the temporary Web page database 67. In next step 144, the schedule program server 8 transmits the display control program to the client system 1. Thereafter, in step 145, when a request for a temporary Web page is received from the client system 1, in step 146, the schedule program server 8 returns the requested temporary Web page to the client system 1. In step 147, if another request for a temporary Web page is received from the client system 1, returning to step 146, the requested temporary Web page is returned to the client system 1. The steps 146 and 147 continue until no more request is received from the client system 1.

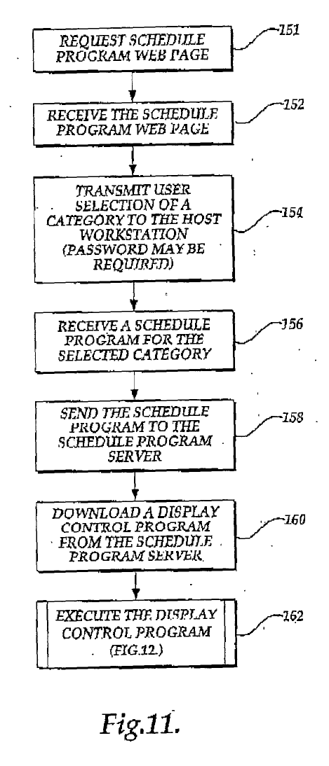

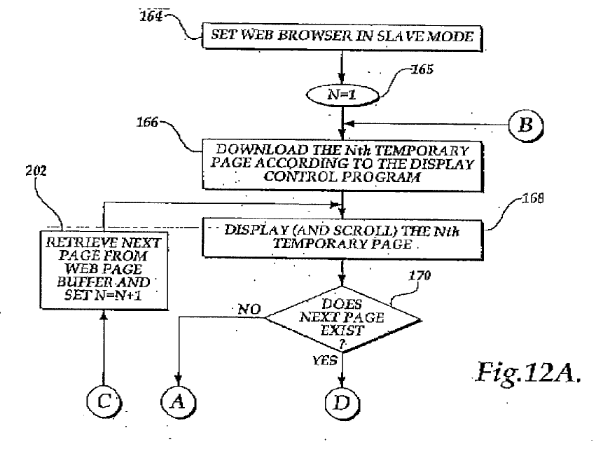

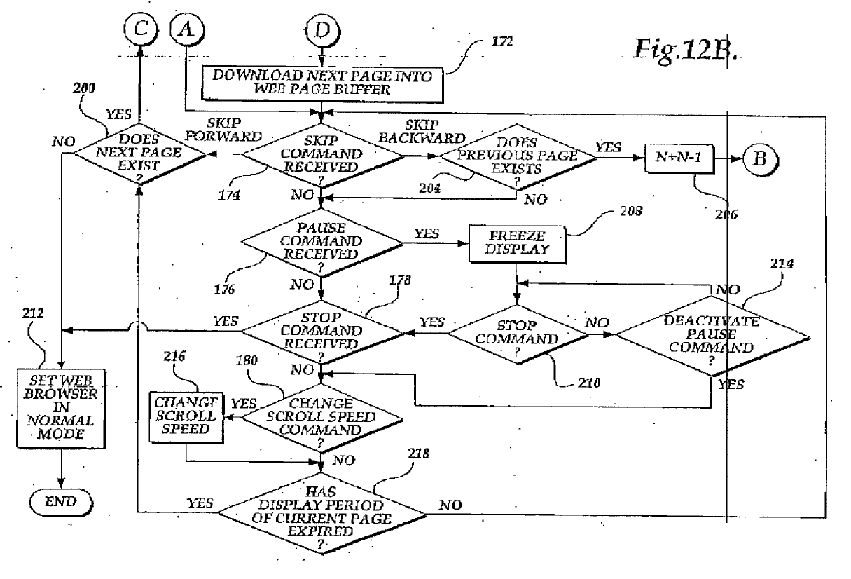

FIG. 11 illustrates the operation of the client system 1 in accordance with one embodiment of the present invention. Referring additionally to FIG. 2, in FIG. 11, step 151, the Web browser 32 requests a schedule program Web page (FIG. 6) from the host workstation 7. In step 152, the requested schedule program Web page is received. In step 154, when the user selects the category of a schedule program, the browser 32 transmits the selected category to the host workstation 7. In step 156, the schedule program for the selected category is received from the host workstation 7. In step 158, the schedule program is automatically sent to the schedule program server 8. Thereafter, as described above, the schedule program server 8 interprets the schedule program and generates temporary Web pages and a display control program in accordance with the schedule program. Then, in step 160, the display control program is downloaded from the schedule program server 8. In step 162, the downloaded display control program is executed to download and display the temporary Web pages on the client system 1 in predetermined order, as more fully described below in reference to FIG. 12.

Still referring additionally to FIG. 2, in FIG. 12, step 164, the schedule program control 36 first sets the Web browser 32 in slave mode. When set in slave mode, the Web browser 32 merely displays and scrolls the Web pages as directed by the schedule program control 36, and does not perform any downloading and displaying of a Web page directed by the user. In step 165, a counter is set to n=1. In next step 166, according to the received display control program, the schedule program control 36 downloads the n^{th} temporary page from the temporary Web page database 67 of the schedule program server 8 (FIG. 3B). In step 168, the downloaded n^{th} temporary Web page is displayed (and scrolled if so specified in the display control program). In step 170, it is determined whether the next page exists. If so, in step 172, the schedule program control 36 immediately starts downloading the next page (n+1^{th} page) into the Web page buffer 34. As will be appreciated by those skilled in the art, such pre-downloading is preferable so that the next page will be immediately available for display upon expiration of the display period of the current page. Next, the schedule program control 36 waits to receive any of four interruption commands, specifically, a skip command in step 174, a pause command in step 176, a stop command in step 178, and a change scroll speed command in step 180.

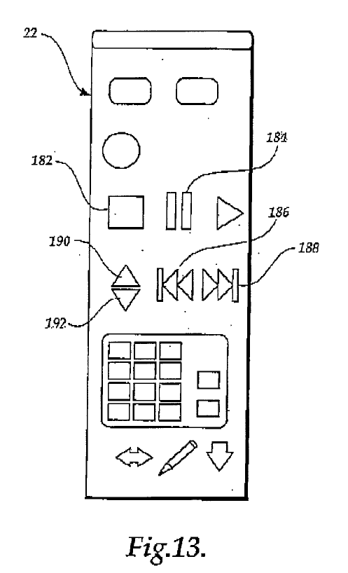

FIG. 13 illustrates a sample input device 22 in the form of a remote control device (for a TV settop box system, for example) suitable for the user of the client system 1 to enter these commands. The input device 22 includes a stop button 182, pause button 184, skip backward button 186, skip forward button 188, scroll speed up button 190, and scroll speed down button 192. Of course, the input device 22 may be of various other configurations and may include other command buttons. In particular, the input device 22 may be in the form of a control panel window that may be displayed on the screen of the client system 1 itself. In this case, the user can point and select a desired command button using a mouse or any other suitable pointing device.

Referring back to FIG. 12, in step 174, if it is determined that the skip forward command has been issued, in step 200, it is determined whether the next page exists. If so, in step 202, the next temporary page already downloaded from the schedule program server 8 is retrieved from the Web page buffer 34 (see step 172), and the counter is increased to n=n+1. At this time, if the next temporary page has not been fully downloaded yet (i.e., step 172 is not completed), step 202 may have to wait until the temporary page is fully downloaded. Then, returning to step 168, this next temporary Web page is displayed (and may be scrolled) on the client system 1. If, in step 174, it is determined that the skip backward command has been issued, in step 204, it is determined if a previous page exists, and if so, in step 206, the counter is decreased to n=n−1. Then returning to step 166, this previous Web page is downloaded from the schedule program server 8, and is displayed (step 168). In step 176, if it is determined that the pause command has been issued, in step 208, the current display on the screen of the client system 1 is frozen (paused). Thereafter, in step 210, if it is determined that the stop command has been issued, then in step 212, the schedule program control 36 sets the Web browser 32 back into normal mode and terminates its operation. Likewise, if in step 178, it is determined that the stop command has been issued (while the display is not paused), then in step 212, the schedule program control 36 sets the Web browser 32 back into normal mode and terminates its operation. If, after the display is paused (step 208), in step 214, it is determined that a command to deactivate pause has been issued (e.g., by pressing the pause button for the second time), next in step 180, it is determined whether the command to change the scroll speed has been issued. If so, in step 216, the scroll speed is increased or decreased, according to the user's command. In step 218, it is determined whether the display period for the current period, as specified in the display control program received from the schedule program server 8, has expired. If not, returning to step 174, the schedule program control 36 again waits to receive any of the command interruptions. On the other hand, if the display period has expired, proceeding to step 200, it is determined whether there is any additional page. If so, in step 202, the next page already downloaded into the Web page buffer 34 is retrieved and the counter is increased to n=n+1. Then, in step 168, the next page is displayed (and scrolled, if necessary). In step 200, if it is determined that there is no additional page, in step 212, the schedule program control 36 sets the Web browser 32 back into normal mode an terminates its operation.

Referring back to FIG. 6, as described above, each of the selectable categories listed in the schedule program Web page 73 may be associated with more than one schedule program. For example, referring additionally back to FIG. 4, each schedule program may be assigned a certain effective time slot and/or priority as part of its attributes 64. If different effective time slots are assigned to different schedule programs, these schedule programs may all be associated with a single category because the different effective time slot arrangement ensures that only one of the schedule programs would be available at any given time of the day when the user selects the category. Further, if there are more than one schedule program whose effective time slot matches the time of the user's selection, the schedule program with the highest priority is selected. If there is no schedule program whose effective time slot matches the time of the user's selection, a schedule program with no effective time slot is selected. If there are more than one such schedule program, the one with the highest priority is selected. Still further, if no priority is assigned to any of available schedule programs, suitable criteria, such as the date of registration of each schedule program within the schedule program database 58 in the host workstation 7 (or the schedule program memory 43 in the client system 1), can be used to select one schedule program. Various other attributes may be assigned to each schedule program to determine its selection order, as will be apparent to those skilled in the art.

It is contemplated that the access to the host workstation 7 and the schedule program server 8 may be limited to those subscribers that pay fees to the operator of a personal Web guide system of the present invention. In this case, referring back to FIG. 3A, the host workstation 7 further includes a user management database 60 in its memory 50, which lists the user names and passwords of all subscribers. Under this scheme, in FIG. 11, step 154, when the client system 1 requests a schedule program of a selected category, the client system 1 will be further required to transmit the user name and password to the host workstation 7. The host workstation 7 then verifies the user name and password against those of the subscribers stored in the user management database 60 and transmits the schedule program to the client user 1 only upon satisfactory verification.

As will be apparent from the foregoing description, according to the present invention, a series of Web pages programmed in a schedule program are automatically displayed on the screen of the client system 1. Therefore, a user, in particular a computer-novice user, of the client system can enjoy viewing the Web pages without having to constantly manipulate the client system. In one embodiment, though, it is contemplated that display of the next Web page may be manually triggered by the user of the client system 1 (e.g., by pressing the skip forward button 188 of the remote control 22 of FIG. 13). In this embodiment, the schedule program and the display control program do not define the display period of each Web page, and rather, the display period of each page is decided by the user of the client system 1.

As will be further apparent from the foregoing description, in accordance with the present invention, because the next Web page may be downloaded while the current Web page is still on display, and because the display period of a Web page is typically longer than the time required to download another Web page, the user can view the next Web page immediately after finishing viewing the current page. Thus, the user does not have to wait between viewing successive pages. While FIG. 12 described an embodiment of the present invention wherein only one next page is downloaded while the current page is on display (step 172), a plurality of next pages may be downloaded while the current page is on display depending on the capacity of the Web page buffer 34 (FIG. 2).

A personal Web guide system of the present invention can be used in connection with not only a relatively unconventional client system, such as a TV settop box system, mobile phone, personal digital assistant, etc., but also with a PC. Furthermore, the personal Web guide system according to the present invention may be useful not only for computer novices but also for those people who are quite familiar with how to browse Web information. For example, some computer users may wish to view a series of the same Web pages everyday, such as the Web pages listing stock information of various companies. In such a case, even if the user is familiar with computer operation, having to download and display the same set of Web pages everyday may still be cumbersome. In particular, the user wastes a considerable amount of time in having to download the next Web page after finishing viewing each Web page. The time required for such downloading, during which the user cannot view any Web page, can be a source of user frustration and adds to the overall time required to view multiple pages as well as the Internet user fees. Therefore, a personal Web guide system of the present invention as described above may be used also by those people who are familiar with computer operation but desire to save time and trouble in browsing a predefined set of Web pages.

In this connection, when a user of the client system 1 is at least minimally familiar with computer operation, it is further contemplated in accordance with the present invention that the client system memory 24 (FIG. 2) may include a schedule program editing system 42, similar to the schedule program editing system 56 of the host workstation 7 (FIG. 3A). The user can then use the editing system 42 to create and edit his or her own schedule program, in a manner described above in reference to FIGS. 7A-9B above. The created schedule programs are stored in the schedule program memory 43 of the client system 1. Likewise, the client system memory 24 may further include a schedule program interpreter 44 and temporary Web page database 45, similar to the schedule program interpreter 63 and the temporary Web page database 67 of the schedule program server 8 (FIG. 3B). In this configuration, the schedule program interpreter 44 of the client system 1 will receive and interpret a schedule program to generate temporary pages and their display control program, in a manner similar to the process illustrated in FIG. 10. The temporary Web pages are stored in the temporary Web page database 45 within the client system memory 24. Then, the schedule program control 36, using the display control program, displays the temporary Web pages in a manner similar to the process illustrated in FIG. 12. In short, in this configuration, the client system 1 is self-sufficient in performing all the functions associated with a schedule program, which were previously distributed amongst the client system 1, the host workstation 7, and the schedule program server 8. This configuration, however, may add to the cost of manufacturing the client system 1, as more functions are assigned thereto. Further, the client system 1 of this configuration may be too difficult to operate for computer-novice users to enjoy the advantage of a personal Web guide system of the present invention.

It should be appreciated by those skilled in the art that, although the host workstation 7 and the schedule program server 8 are illustrated as two independent components, they can be consolidated into one component, or their functions can be further distributed amongst a plurality of computers and servers. Also, though the foregoing description focused on displaying Web pages, a Web guide system of the present invention can also be applied to displaying other types of Web information that can be displayed on a screen of the client system.

While the preferred embodiments of the invention have been illustrated and described, it will be appreciated that various changes can be made therein without departing from the spirit and scope of the invention.

The embodiments of the invention in which an exclusive property or privilege is claimed are defined as follows:

1. A personal Web guide system which allows a user to browse Web information according to a predetermined schedule, the system comprising:
a schedule program memory including a schedule program in which a plurality of Internet resource addresses are registered in predetermined sequential order; and
a client system including a display, the client system being configured to download plural sets of Internet resource data whose addresses are registered in the schedule program from the Internet, and to display the plural sets of downloaded data in the predetermined sequential order on the display.

2. The personal Web guide system of claim 1, wherein the schedule program memory resides in a host server with which the client system is connected via the Internet and from which the client system retrieves the schedule program.

3. The personal Web guide system of claim 1, wherein the schedule program memory includes a plurality of schedule programs predefined under a plurality of categories, respectively, each of which is selectable by the client system.

4. The personal Web guide system of claim 1, wherein the client system is selected from a group consisting of a TV settop box system, a mobile phone, and a personal digital assistant.

5. The personal Web guide system of claim 1, wherein the schedule program further defines a display period for each of the plural sets of Internet resource data, and the client system displays each of the plural sets of Internet resource data for the predefined display period.

6. The personal Web guide system of claim 5, wherein the schedule program is used to create a plurality of temporary Web pages based on the plural sets of Internet resource data, respectively, and also to create a display control program defining the address and display period of each of the plurality of temporary Web pages.

7. The personal Web guide system of claim 6, wherein the display control program further defines scrolling of at least one of the plurality of temporary Web pages.

8. The personal Web guide system of claim 6, wherein at least one of the plurality of temporary Web pages is reformatted for display on the client system.

9. The personal Web guide system of claim 1, wherein the client system further comprises a buffer configured to store Internet resource data, the client system being configured to download plural sets of Internet resource data whose addresses are registered in the schedule program from the Internet into the buffer, and to display the downloaded plural sets of data in the predetermined sequential order on the display;
wherein the client system downloads a set of Internet resource data from the next Internet resource address as specified in the schedule program before completing the display of another set of Internet resource data from the current Internet resource address as specified in the schedule program.

10. A personal Web guide system which allows a user of a client system to browse Web information according to a predetermined schedule, the system comprising:
a host workstation comprising a schedule program memory, the memory including a schedule program in which a plurality of Internet resource addresses are registered in predetermined sequential order;
a schedule program server connected to the host workstation, the schedule program server being configured to receive a schedule program and to create a plurality of temporary Web pages and a display control program based on the received schedule program, the plurality of temporary Web pages being created based on a plurality of Web pages available at the plurality of Internet resource addresses as registered in the schedule program, respectively; and
a client system including a display, the client system being configured to download the display control program from the schedule program server, and then to download and display the temporary Web pages in the predetermined sequential order according to the downloaded display control program.

11. An article comprising a computer-readable signal-bearing medium including computer-executable instructions, wherein the instructions when loaded onto a computer perform the steps of:
receiving user input of a plurality of Internet resource addresses in user-selected sequential order; and
generating a schedule program in which the plurality of Internet resource addresses are registered in the user-selected sequential order.

12. The article of claim 11, wherein the medium is a recordable data storage medium.

13. The article of claim 11, wherein the medium is a modulated carrier signal.

14. The article of claim 11, wherein the step of receiving user input further includes receiving user input of a display period for each of the plural sets of Internet resource data available at the plurality of Internet resource addresses, respectively, and the schedule program further defines the display period of each of the plural sets of Internet resource data.

15. The article of claim 14, wherein the step of receiving user input further includes receiving user input of scrolling at least one of the plural sets of Internet resource data, and the schedule program further defines the scrolling of at least one of the plural sets of Internet resource data.

16. The article of claim 14, wherein the step of receiving user input further includes receiving user input of reformatting at least one of the plural sets of Internet resource data.

17. The article of claim 14, wherein the computer-executable instructions perform the further step of:
interpreting the schedule program to generate a plurality of temporary Web pages based on the plural sets of Internet resource data, respectively, and to generate a display control program defining the address and display period of each of the plurality of temporary Web pages.

18. An article comprising a computer-readable signal-bearing medium comprising a schedule program in which a plurality of Internet resource addresses are registered in predetermined sequential order.

19. The article of claim 18, wherein the schedule program further defines the display period of each of the plural sets of Internet resource data available at the plurality of Internet resource addresses, respectively.

20. The article of claim 19, wherein the medium further comprises computer-executable instructions which, when loaded onto a computer, perform the step of:
interpreting the schedule program to generate a plurality of temporary Web pages based on the plural sets of Internet resource data, respectively, and to generate a display control program defining the address and display period of each of the plurality of temporary Web pages.

21. The article of claim 18, wherein the schedule program further defines scrolling of at least one of the plural sets of Internet resource data.

22. The article of claim 18, wherein at least one of the plural sets of Internet resource data is reformatted in the schedule program.

23. An article comprising a computer-readable signal-bearing medium including computer-executable instructions, wherein the instructions when loaded onto a computer perform the steps of:
downloading a display control program in which a plurality of Internet resource addresses are registered in predetermined sequential order; and
downloading and displaying plural sets of Internet resource data available at the plurality of Internet resource addresses, respectively, in the predetermined sequential order according to the display control program.

24. The article of claim 23, wherein the display control program further defines a display period of each of the plural sets of Internet resource data, and the step of downloading and displaying the plural sets of Internet resource data comprises displaying each set of Internet resource data for the predefined display period.

25. The article of claim 23, wherein the step of downloading and displaying the plural sets of Internet resource data comprises downloading a set of Internet resource data from the next Internet resource address as specified in the display control program before completing the display of another set of Internet resource data from the current Internet resource address as specified in the display control program.

26. The article of claim 23, wherein the display control program further defines scrolling of at least one of the plural sets of Internet resource data, and the step of downloading and displaying the plural sets of Internet resource data comprises scrolling at least one of the plural sets of Internet resource data according to the display control program.

27. The article of claim 23, wherein the display control program further defines reformatting at least one of the plural sets of Internet resource data, and the step of downloading and displaying the plural sets of Internet resource data comprises displaying at least one of the plural sets of Internet resource data as reformatted according to the display control program.

28. The article of claim 23, wherein the medium is a recordable data storage medium.

29. The article of claim 23, wherein the medium is a modulated carrier signal.

30. A method of automatically displaying a series of Web pages on a client system, the method comprising:
listing a plurality of categories on a client system, each of the categories being associated with a schedule program;
receiving a user selection of one of the categories on the client system; and
in response to the user selection, automatically displaying a plurality of Web pages on the client system in sequence as predetermined in the schedule program associated with the selected category.

31. The method of claim 30, wherein the schedule program further defines a display period for each of the plurality of Web pages, and the step of displaying a plurality of Web pages comprises displaying the Web pages for the defined display periods, respectively.

32. The method of claim 30, wherein the schedule program further defines scrolling of at least one of the plurality of Web pages, and the step of displaying a plurality of Web pages comprises scrolling the at least one of the Web pages.

33. The method of claim 30, further comprising the steps of:
receiving a user password on the client system; and
verifying the received user password to determine if it matches a predefined subscriber;
wherein only upon verifying that the received password matches a predefined subscriber, the step of automatically displaying a plurality of Web pages is performed.
